(19) United States
(12) Patent Application Publication
(10) Pub. No.: US 2003/0095309 A1
(43) Pub. Date: May 22, 2003

(54) Multi-wavelength optical access networks

(76) Inventors: Nima Ahmadvand, Ottawa (CA); Hamid Hatami-Hanza, Ottawa (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 10/262,861

(22) Filed: Oct. 3, 2002

(30) Foreign Application Priority Data
Oct. 4, 2001 (CA) 2,358,206

(51) Int. Cl. H04J 14/02

(52) U.S. Cl. 359/127; 359/132; 359/125

(57) ABSTRACT

In an optical access network architecture based on Dense Wavelength Division Multiplexing (DWDM) a central laser source in the central station provides a large number of wavelength channels. Optical interleavers are then used to partition and finally demultiplex the set of available wavelengths to provide one bi-directional wavelength channel per access node, the central station being the only laser source in this network. The laser source provides a large number of very tightly spaced wavelength channels. Each access node retrieves the laser source from the signal received from the central station to be used in modulating its upstream signals. This access network architecture provides one wavelength channel for each access node, and hence enables protocol and data rate transparency on each channel.

### BACKGROUND OF THE INVENTION

1. Field of the Invention

The present invention relates to optical networks in general and in particular to passive optical networks. More particularly, it relates to passive optical networks for the access side of the telecommunication networks.

2. Prior Art of the Invention

At present, the main challenge remains to be the transfer of the information en masse. The huge growth in telecommunication technology enables massive data files transfers. Optical networking has provided data transfer capacities in the range of several tera-bits-per-second in the long haul and ultra long haul telecommunication networks. These networks, however, form only the backbone of the telecommunication networks.

The large capacity in the backbone network potentially enables a large number of applications that require transfer of large amounts of data. These applications include video conferencing, distributed processing, medical imaging and many others. At the same time, new applications are becoming progressively feasible. These new applications benefit from very complex data structures as well as efficient user interfaces, which in turn causes the sizes of these computer programs to become very large. On the other hand, large penetration of the Internet into offices and homes necessitates much higher data transfer capacities from the backbone networks as well as other parts of the Internet, especially the access networks.

In general, nodes at the edges of the large networks, in particular the Internet, are connected to the each other through a number of intermediate stages. In this configuration, each access node is connected to a Local Area Network (LAN) or an Access Network. These networks are then connected to Metropolitan Area Networks (MAN). Finally, MANs can communicate through Wide Area Networks (WAN), which form the backbone network. The optical networking technology, particularly Dense Wavelength Division Multiplexing (DWDM) has provided large capacity for the long haul networks. The data to be transferred by the backbone network must first be collected from the access nodes. However, the access network technology has not been able to catch up with the progress in the backbone.

In the access networks, several nodes are connected to each other through some network architectures with a number of different topologies, such as star, ring or bus. In any case, the network is connected to the outside world through specific nodes, which are called routers. The main protocol that is used for internetworking is the IP (Internet Protocol). As an example, we may consider a number of nodes connected through a LAN using Ethernet. In order for a node in this network to connect to the outside world, it needs to send its data in form of IP packets over the Ethernet protocol to the router. The router collects all the IP packets and encapsulates them into another type of link layer protocol frames. It then send this data onto its outside link(s). Bigger IP routers in a MAN would collect the data sent by these routers. We should note, however, that routers in the network, especially those in the access networks are protocol dependent. As a result, very sophisticated hardware and software techniques must be used to realize an efficient routing. On the other hand, data rates needed by various access nodes may be very different. For example, an email access needs a very low data rate connection that is not sensitive to delay. However, a video conferencing terminal requires a high data rate connection with very low delay.

In order to support different networking protocols as well as various data rates and probably different Qualitys of Service (QoS), very complicated routers and protocols have been proposed and implemented.

Finally, the access networks must be very cost effective. The price per node must provide enough attraction for old access network users to implement the new technology.

A number of configurations have been proposed to address the need for a large bandwidth in the access networks. One category of the new architectures is Passive Optical Networks (PONs). Two types of PONs have been studied and attracted more attention than others: Ethernet PONs and ATM PONs. As is obvious from their names, they are bound to specific protocols to transport data. In general, in almost all designs broadcast network architectures are used where generally a central station (sometimes called head-end) on the network controls access to the network In many cases the stations access and send data based on Time Division Multiple Access (TDMA) method. This immediately brings up the issue of time synchronization in the network. As a result, some protocols are needed to insure time synchronization. The final result is that the total solution is complex and hence expensive.

The present invention introduces, a novel design which benefits from DWDM technology to provide a very simple and cost effective network architecture, which is protocol transparent and can support different data rates as well.

### SUMMARY OF THE INVENTION

The present invention provides optical access network architecture based on Dense Wavelength Division Multiplexing (DWDM) with a large number of wavelength channels. In this configuration, a central laser source in the central station provides a large number of wavelength channels. Optical interleavers are then used to partition and finally demultiplex the set of available wavelengths to provide one bi-directional wavelength channel per access node. In this arrangement, the central station is the only laser source in this network. This laser source is able to provide a large number of very tightly spaced wavelength channels. Each access node retrieves the laser source from the signal received from the central station to be used in modulating its upstream signals. This access network architecture provides one wavelength channel for each access node, hence enables protocol and data rate transparency on each channel.

A novel feature of this access network is the simplicity and ease of wavelength channel management, where a new technique is used that enables a very efficient distribution and demultiplexing of the wavelength channels. As a result, the network provides a simple fiber distribution and management. In this configuration, a number of optical interleaver stages are used to demultiplex wavelength channels. In each stage, the set of equally spaced wavelength channels at the input are demultiplexed (de-interleaved) into two sets of channels where the channel spacing is double the size of the original spacing. With consecutive applications of de-interleaving each individual channel is selected for each node. Optical interleavers are bi-directional devices. In the upstream direction, interleavers multiplex channels into tighter spaced channels.

The access network architecture according to the present invention may also be categorized as a Passive Optical Network (PON). This architecture is, however, different from prior art architectures in that it uses a combined demultiplexing and distribution technique, which provides a very efficient fiber placement and management. The network topology is a tree, where the central station is connected to the access nodes in a branching tree architecture. In each branching stage, an optical interleaver is used to divide the set of available equally spaced channels in that stage to two sets of channels where each set has a channel spacing of twice as that of the original set.

Accordingly, a method of the present invention for providing multi-wavelength optical access to access nodes in optical communication systems, comprising the steps of generating a plurality of optical laser signals from a single laser source; each of said optical singles having a unique wavelength. Modulating predetermined ones of said optical signals with predetermined ones of a plurality of data signals. Multiplexing said optical signals onto a single optical transmission medium, and bi-directionally demultiplexing and multiplexing said optical signals transmitted on said transmission medium in successive MUX/DEMUX-interleaver stages to provide up to N single access nodes, where N=2ⁿ, n being the number of MUX/DEMUX-interleaver stages.

A system for providing multi-wavelength optical access to access nodes in optical communication systems, comprising a single multi-wavelength laser source for providing N optical carriers. A plurality of optical modulators for modulating up to N of said optical carriers with up to N data signals. Means for multiplexing up to N optical carriers onto an optical transmission medium and means for demultiplexing up to N optical carriers transmitted via the transmission medium to provide access to said access nodes of up to N said data signals.

The system as defined above, wherein the means to demultiplexing comprises n successive demultiplexing stages, where N=2ⁿ.

The system as defined above wherein the means for demultiplexing demultiplex in direction of the access nodes (downstream) and multiplex in direction from the access nodes (upstream).

The system as defined above, wherein multiplexing downstream and demultiplexing upstream is performed by means of bidirectional DWDM interleavers.

### BRIEF DESCRIPTION OF THE DRAWINGS

The preferred exemplary embodiments of the present invention will now be described in detail in conjunction with the annexed drawings, in which:

FIG. 1 shows the architecture of the access network introduced in this invention,

FIG. 2 illustrates the function of an optical interleaver;

FIGS. 3 and 3b display the modularity of the design in terms of combining a number of interleaver stages; FIG. 3a a two stage (1×4) interleaver and FIG. 3b a three stage (1×8) interleaver; and

FIG. 4 shows the scheme used in the access nodes to retrieve data as well as the laser source.

### DETAILED DESCRIPTION OF THE PREFERRED EMBODIMENTS

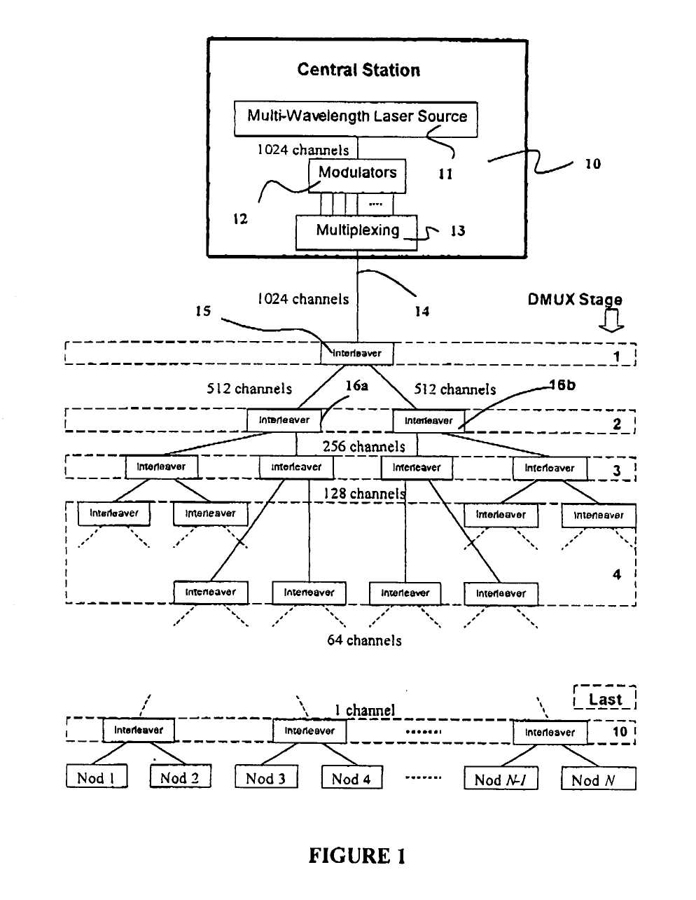

Referring now to the drawing figures, the novel access network based on Dense Wavelength Division Multiplexing (DWDM) is described. As shown in FIG. 1, a “demultiplexing and distribution” technique is used to assign one wavelength channel to each access node. In this configuration, a central station 10 has a master Multi-Wavelength Laser Source (MWLS) 11 is used as the only optical source in the whole access network, which can also provide a large number of wavelength channels. The multi-wavelength optical power at the output of the central station 10 is demultiplexed in different stages (1 to 10) to provide sets of channels to be distributed to different clusters and eventually to each access node. Raving one master MWLS 11 in the central station provides a very efficient means to control and synchronize all the wavelength channels, since any wavelength stability provisioning or control can be applied easily and cost effectively at one point in the whole network.

The central station 10 modulates via modulators 12 individual wavelength channels provided by the single multi-wavelength laser source 11 with the data corresponding to each of the access nodes. These channels are then multiplexed via MUX 13 onto one output fiber 14 to be transmitted to all the nodes. In the example shown in FIG. 1, the available wavelength set consists of 1024 channels. In the first interleaver stage 15, these channels are partitioned into two sets of 512 channels. After the second interleaver stage 16a and 16b four sets of channels each with 256 channels form. By consecutive application of interleaver stages, individual channels are separated in the last stage, which is the tenth stage in this example (1024=2¹⁰). It is observed that this method provides a very efficient fiber management and distribution, since it simultaneously distributes and demultiplexes wavelength channels.

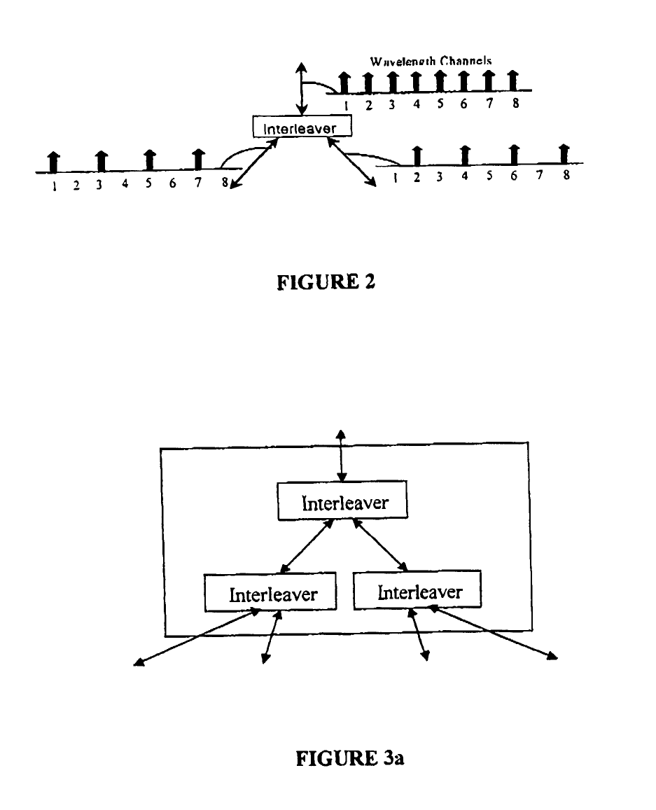

An optical interleaver is shown in FIG. 2. For example, if there are 2n channels spaced at 100 GHz in the input of an interleaver stage, each output branch carries n channels spaced at 200 GHz. This doubling of the channel spacing is also illustrated in FIG. 2. From 8 channels at the input, numbered as channels 1, 2, . . . , 8, odd channels are directed to the first output and even channels to the second. Furthermore, optical interleaver is a bi-directional device, i.e. it interleaves channels in one direction (upstream here) and de-interleave in the other direction (downstream).

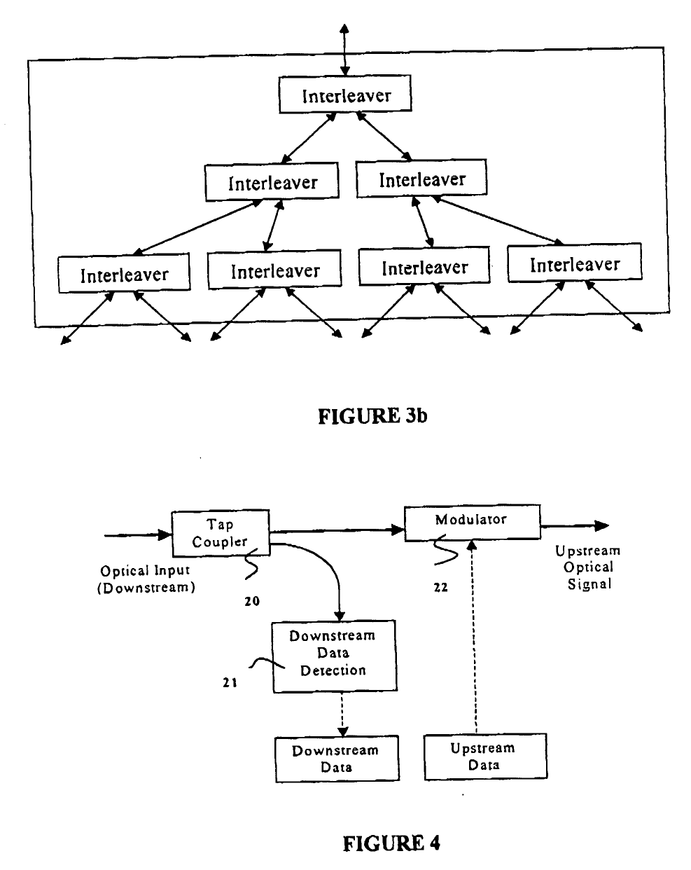

A further advantage of the present system is its modularity, in the sense that a number of interleaver stages can be combined together to enable some level of central multiplexing/demultiplexing. Two examples are shown in FIGS. 3a and 3b. This also highlights the flexibility of the architecture. This is because of the fact that the length of the fiber connection between adjacent stages can be determined based on the geographical distribution of the MUX/DMUX and access nodes. FIG. 3a shows an example of two-stage interleaver module (1 to 4 MUX/DMUX) and FIG. 3b shows a three-stage interleaver module (1 to 8 MUX/DMUX). The present system also enables provision of more than one channel to specified nodes that require higher capacities. This is simply done by assigning multiple wavelength channels to these nodes.

Finally, in the present system and method, the access nodes do not require any laser source, since each node can re-use the optical power sent by the central station to modulate its data in the upstream direction. This is shown in FIG. 4. A fraction of the optical input signal (downstream signal) is tapped in coupler 20 for the optical detector 21. The remaining part of the signal is used as the laser source for the external modulator 22 at the access node.

The extraction of the carrier optical signal from the downstream signal is possible if two different modulation techniques are used in the access node and the central station. For example, phase modulation can be used in the central station, while simple intensity modulation is used in the access nodes. However, in order to reduce the cost of modulation and detection, simple intensity modulation can be used in both central station and access nodes. In this case, access nodes use deeper intensity modulation than the one used in the central station, i.e. different modulation factors.

What is claimed is:

1. A method for providing multi-wavelength optical access to access nodes in optical communication systems, comprising the steps of:
(a) generating a plurality of optical laser signals from a single laser source;
each of said optical singles having a unique wavelength;
(b) modulating predetermined ones of said optical signals with predetermined ones of a plurality of data signals;
(c) multiplexing said optical signals onto a single optical transmission medium; and
(d) bi-directionally demultiplexing and multiplexing said optical signals transmitted on said transmission medium in successive MUX/DEMUX-interleaver stages to provide up to N single access nodes, where N=2ⁿ, n being the number of MUX/DEMUX-interleaver stages.

2. A system for providing multi-wavelength optical access to access nodes in optical communication systems, comprising:
(a) a single multi-wavelength laser source for providing N optical carriers;
(b) a plurality of optical modulators for modulating up to N of said optical carriers with up to N data signals;
(c) means for multiplexing up to N optical carriers onto an optical transmission medium;
(d) means for demultiplexing up to N optical carriers transmitted via the transmission medium to provide access to said access nodes of up to N said data signals.

3. The system as defined in claim 2, wherein the means to demultiplexing comprises n successive demultiplexing stages, where N=2ⁿ.

4. The system as defined in claim 2, wherein the means for demultiplexing demultiplex in direction of the access nodes (downstream) and multiplex in direction from the access nodes (upstream).

5. The system as defined in claim 3, wherein multiplexing downstream and demultiplexing upstream is performed by means of bi-directional DWDM interleavers.
